(19) United States
(12) Patent Application Publication
(10) Pub. No.: US 2025/0268689 A1
(43) Pub. Date: Aug. 28, 2025

(54) METHOD OF MAKING NET SHAPED DENTAL DEVICES

(71) Applicant: Kenneth E. Knapp, Chula Vista, CA (US)

(72) Inventor: Kenneth E. Knapp, Chula Vista, CA (US)

(21) Appl. No.: 18/586,466

(22) Filed: Feb. 24, 2024

Related U.S. Application Data
(60) Provisional application No. 63/448,147, filed on Feb. 24, 2023.

(51) Int. Cl. A61C 3/00; C04B 35/488

(52) U.S. Cl. CPC A61C 3/00; C04B 35/4885; C04B 2235/3217; C04B 2235/3225; C04B 2235/3244; C04B 2235/3418

(57) ABSTRACT

The present application discloses additive manufactured dental devices and methods for making net shaped ceramic and metallic dental devices by a 3D laser chemical vapor deposition method using a mixed gaseous state chemical vapor source. Dental zirconia dental prosthetic devices are made to replicate the heterogenous natural optical characteristics of natural tooth dentition. In this embodiment a method for fabricating net shaped dental devices with a heterogeneous discrete volumetric compositional and material growth morphology variations within a net shaped dental prosthetic body that mimics natural tooth dentition comprising ceramic and metallic materials is disclosed.

### CROSS-REFERENCE TO RELATED APPLICATIONS

This application claims the benefit of U.S. provisional application Ser. No. 63/448,147, filed on Feb. 24, 2023 by the present inventor, which is incorporated by reference in its entirety.

### PRIOR ART

The present state of computer aided design/computer aided manufacturing (CAD)/(CAM) of all ceramic dental prosthetic devices consists of a computer controlled substrative machining method of a porous zirconia blank dental ceramic material in the green state, bisque state or of a pre-colored dense sintered zirconia dental ceramic material blank or a pre-colored glass-ceramic blank. Disadvantageously, dental zirconia ceramic materials comprising porous green state, bisque state, sintered zirconia ceramic or glass-ceramic blanks consist of an unesthetic near homogeneous color and a reduced optical translucency. These ceramic materials are unesthetic as compared to the heterogeneous color, greater translucency and internal optical characteristics as compared to that of a natural tooth. These ceramic dental prosthetic devices typically require further post machining processes, such as sintering, application of metal ion colorant solutions to the porous green state or bisque state dental ceramic materials by hand. Adding additional layers of dental porcelain glass by hand or by pressing a glass-ceramic layer over the machined dental prosthetic device in order to achieve an acceptable esthetic ceramic tooth like dental device. Additionally, these ceramic dental devices typically have a rough surface due to the machining and require smoothing and polishing by hand or the application of a dental porcelain glass glaze followed by an additional furnace firing.

Fabrication of all ceramic dental prosthetic devices by subtractive machining methods is wasteful with respect to the zirconia ceramic blank materials used, energy to machine, energy for sintering, energy for fabricating the blanks by powder compaction. Additionally, the time-consuming process of applying metal ion coloring solutions by hand, adding the porcelain glass layer and polishing the outer surface by hand.

One ceramic material known for producing blanks for subtractive machining consists of an yttria-stabilized zirconia material. A disadvantage of these materials used in dentistry is the reduced optical transmission as compared to the dental glass-ceramics and the porcelain glass materials. While yttria-stabilized zirconia (YSZ) has a high flexural strength exceeding 800 MPa the optical transmission of sintered (YSZ) is lower compared to dental porcelain glass and to glass-ceramics because of optical birefringence.

Another ceramic material known for producing blanks for subtractive machining consists of the glass-ceramic materials such as a lithium disilicate or a lithium silicate material. A disadvantage of these ceramic materials used in dentistry is the reduced optical transmission compared to dental ceramic glass porcelain materials, that is typically applied by hand or pressed over a machined dental substructure prosthesis. Additionally, the lithium disilicate materials typically have a flexural strength less than 550 MPa which limits their dental prosthetic device applications.

Methods of fabricating dental crown by subtractive machining from ceramic blanks are disclosed in the following patents and patent applications:

U.S. Pat. No. 10,004,668 discloses a bisque state zirconia dental ceramic material mainly tetragonal with less than monoclinic and cubic phases combined with sintered grains 10 nm-300 nm at 99.5% density adjusting esthetic translucency properties with grain size. This disclosure specified sintering of the zirconia to achieve the final ceramic state.

U.S. Pat. No. 10,034,728 discloses a method of coloring pre-sintered zirconia restorations with a liquid with subsequent coloring liquids being blocked by the previous coloring liquids to have differing sintered colors between cervical and occlusal parts of the zirconia dental restoration.

U.S. Pat. No. 10,226,313 discloses a method of forming a multilayer zirconia disc with varying yttria concentration to improve esthetics. Method of coloring pre-sintered restorations by dipping in coloring solutions for improved esthetics. This patent discloses post machining coloring and sintering in addition to machining the zirconia dental product.

U.S. Pat. No. 10,238,473 discloses a method of forming a multilayer zirconia disc with varying yttria concentration to improve esthetics.

U.S. Pat. No. 10,292,795 discloses a method for coloring porous pre-sintered dental zirconia with coloring solutions with metal cations of Fe, Mn, Er, Pr, V, Cr, Co, Mo, Ce, Tb and their mixtures.

U.S. Pat. No. 10,315,958 discloses a method of using a porous ceria stabilized zirconia for dental frameworks for improving low temperature degradation (LTD).

U.S. Pat. No. 10,479,729 discloses a method of a dental ceramic body with coloring ions of Tb, Cr, Er, Co, Mn, Pr, V, Ti, Ni, Cu and Zn of sintered preforms and zirconia powders. Pre-sintered and porous for milling.

U.S. Pat. No. 10,532,008 discloses a method for shaded zirconia with 4.7-5.1 at % yttria with coloring agent of terbia, chromia, europium and cobalt oxide with specific composition ranges. Process by slip casting to produce porous zirconia, requiring sintering.

U.S. Pat. No. 11,142,478 discloses a method of a zirconia silica dental ceramic made by mixing a Sol solution and casting materials. Produces a green body requiring sintering.

U.S. Pat. No. 11,180,417 discloses a method of producing a sintered body of zirconia, yttria and alumina for a higher strength of 2000 MPA and hydrothermal stability.

U.S. Pat. No. 11,298,213 discloses a method of adding an antimicrobial layer into a pre-sintered porous zirconia dental device by dipping into a solution containing (Mo) cations. Applied to zirconia near gingiva region.

U.S. Pat. No. 11,504,304 discloses a method by adding yttria to pre-sintered porous zirconia milled crown to increase optical transmission, in the amount of 2-7 at. %.

US2011/0183281 discloses a method for coating dental devices with zirconia for esthetic purposes. Coating method using physical vapor deposition (PVD) methods and masking, ceramic materials.

US2019/0233340 discloses a method fabricating multicolored zirconia dental disc for milling. Varying through the block thickness.

US2022/0183804 discloses a method for making zirconia crown coloring chemicals, pink from erbium oxide.

U.S. Pat. No. 7,497,983 discloses a method of coloring porous milled zirconia crown using atmosphere from a colored powder.

U.S. Pat. No. 8,298,329 discloses a method of making nanocrystalline zirconia dental ceramic using a chemical vapor synthesis (CVS) with metal organic chemical vapors to generate nanograin powder with improved optical transmission.

U.S. Pat. No. 11,564,773 discloses a method of making esthetic dental (YSZ) crowns by machining from a sintered preformed zirconia blank.

Another known (CAD/CAM) method for producing dental ceramic prosthetic devices is by an additive manufacturing (AM) method using a digital light projection (DLP) image source or a laser based stereolithography (SLA) method, whereby the solid body is built up by printing a series of layers of a photosensitive polymer material containing a ceramic powder material instead of the subtractive methods disclosed above. These (AM) methods use a ceramic containing powder, or a colloidal suspension of ceramic particles (sols) suspended in a vat of a photopolymer. Layers are printed successively on a buildup plate suspended in the vat of a mixture of the ceramic materials and the photopolymers. Printing is done using the digital light projection (DLP) or the laser based stereolithography (SLA) method using a light source at an optical wavelength of typically 405 nanometers. Disadvantageously, these additive manufacturing methods produce an unesthetic, porous green state zirconia ceramic or green state lithium disilicate part comprised of a homogeneous material, typically requiring post processing such as sintering, application of metal ion colorant solutions by hand or adding additional layers of dental ceramic porcelain to achieve an acceptable esthetic ceramic dental prosthesis.

Methods of fabricating dental ceramic prosthetic devices by additive manufacturing using (DLP) and/or (SLA) is disclosed in the following patents and patent applications:

U.S. Pat. No. 10,864,675 discloses a (DLP/SLA) type of printer using a viscous ceramic loaded photopolymer material to build 3D structures in a layered method.

U.S. Pat. No. 11,500,354 discloses a method and device to produce custom 3D (DLP printed) orthodontic bracket using commercially available zirconia or alumina photosensitive light polymerizable slurries. Green body requires burn out and sintering.

US2022/0380260 discloses a method of a dental restorative ceramic article formed by 3D printing a photo curing a sol or slurry consisting of a photopolymerizable slurry loaded with ceramic nanoparticles. Includes a range of inorganics for coloring. 3D printing by SLA or DLP, process includes burn out of photopolymer and sintering.

U.S. Pat. No. 10,759,707 discloses a method for producing ceramic articles using a 3D printable Sol with photo curable monomer and photo initiator. Requires post processing heat treatment. Includes dental and orthodontic devices.

U.S. Pat. No. 11,339,095 discloses a method for 3D printing a green body ceramic dental device by SLA in a Sol consisting of oxides. Includes coloring oxides. Requires burn out and sintering for final density.

U.S. Pat. No. 11,358,327 discloses a method for producing dental devices using 3D SLA/DLP printing method using a flowable resin in conjunction with a jet nozzle to smooth and level the printed part during printing. Produces green body requires sintering.

Another known (CAD/CAM) method for producing metallic or ceramic dental prosthetic devices is by a 3D additive manufacturing method whereby the solid body is built up by printing a series of layers of metallic or ceramic containing powder materials. Such methods use metallic or ceramic containing powders dispensed in layers along with a nozzle head containing a binding agent. Layers are printed successively on a buildup plate by repeating the process of applying a thin layer and then dispensing droplets of a binder, fusing together particle regions with a binding agent resulting in a porous body. Disadvantageously, these additive manufacturing methods produce a porous unesthetic, near homogeneous ceramic, ceramic/glass composition that typically requires post processing such as sintering, and the application of a metal ion colorant solutions by hand or adding additional layers of dental ceramic porcelain in order to achieve an acceptable esthetic ceramic dental device.

Methods of fabricating dental ceramic prosthetic devices by additive manufacturing using binder jetting type methods is disclosed in the following patents and patent applications:

U.S. Pat. No. 11,541,568 discloses binder jet printing of a variety of ceramic materials, carbon loaded for microwave sintering, requires sintering post processing.

US2017/0056138 discloses an inkjet jet additive 3D printing process for functionally graded ceramic crowns. Print spot 5-10 microns before sintering. Requires post firing to sinter ceramic crowns. Ceramic is homogenous in XY build plane and graded in Z plane. Requires post processing burn out and sintering with shrinkage.

U.S. Pat. No. 9,155,597 discloses a solid freeform (SFF) method using a binder jet for printing zirconia dental restorations.

Another known (CAD/CAM) method for producing dental metallic or ceramic prosthetic devices is by a selective laser melting (SLM) and/or selective laser sintering (SLS) 3D additive manufacturing methods. Whereby a net shaped solid body is built up by laying down a series of layers of a ceramic containing powder and/or a metal material. Such methods use a laser in conjunction with a method of dispensing a layer of powders. Layers are printed successively on a buildup plate by repeating the process of applying a thin layer of a metallic or the ceramic powder, followed by scanning a laser beam spot selectively incident upon the powder in a predetermined pattern, and fusing or sintering the powders to the adjoining underlying body. Disadvantageously, these additive manufacturing methods produce an unesthetic, near homogeneous ceramic, ceramic/glass composition, typically requiring post processing, such as separating the body from unsolidified coating powder, removal of support structures or additional layers of dental ceramic porcelain to achieve an acceptable esthetic ceramic dental device.

U.S. Pat. No. 9,556,525 discloses a (SLM)/(SLS) method of producing net shape ceramic dental devices. Using powder bed with one laser for preheating and another for spot sintering. Planar powder for printing uniform powder composition in one plane. Using lasers and other-directed energy sources.

Another known (CAD/CAM) method for producing the dental ceramic prosthesis is by a laser-induced forward transfer (LIFT) additive manufacturing method. Whereby a green state near net shaped solid body is built up by a series of layers comprising droplets of a ceramic powder/polymer matrix. Layers are printed successively on a buildup plate by repeating the process of applying a layer of droplets by scanning a laser beam spot selectively incident upon a sacrificial donner film containing the ceramic powder/polymer matrix material. The localized heating induced by the laser spot causes the donor film to eject a molten droplet that transports forward to the underlying buildup plate. Disadvantageously, this additive manufacturing method produce an unesthetic, near homogeneous ceramic or ceramic/glass composition, typically requiring post processing, such as sintering, and the application of a metal ion colorant solutions by hand or adding additional layers of dental ceramic porcelain in order to achieve an acceptable esthetic ceramic dental device.

Method of fabricating dental ceramic prosthetic devices by additive manufacturing using the (LIFT) method is disclosed in the following patent application:

U.S. Pat. No. 20,200,172444 A1 discloses a (LIFT) method using slips and processes for the production of ceramic or glass ceramic shaped parts such as dental prosthesis.

### BACKGROUND OF THE INVENTION

### Technical Field

This invention is related to the fabrication of ceramic and metallic dental prosthetic devices by a selective area deposition additive manufacturing method.

### SUMMARY OF THE INVENTION

Instead of producing zirconia ceramic dental prosthetic devices by a conventional subtractive machining method, the present application discloses a novel additive manufacturing approach and dental devices comprised of a three-dimensional laser chemical vapor deposition (3D-LCVD) method to produce a net shaped colored zirconia ceramic dental prosthesis that does not need to be sintered or altered with coloring solutions.

Dental prosthetic devices fabricated by the disclosed (3D-LCVD) method can be made to replicate the color, optical transmittance and the internal optical characterization of a natural tooths dentition without further alteration. Additionally, the zirconia ceramic dental prosthesis color and the internal optical characterization of the net shaped zirconia ceramic dental device disclosed in this application can be designed and controlled by the (3D-LCVD) method. Within the net shaped zirconia ceramic body, comprising microscopic volumes of a plurality of zirconia ceramic compositions and a plurality of growth morphologies can be controlled by the (3D-LCVD) solidification process of a select chemical vapor deposited volume. Additionally, the growth morphology can be controlled, comprising an amorphous zirconia phase, a nanocrystalline phase and a textured columnar single crystalline phase and/or a combination of the amorphous phase, nanocrystalline phase and columnar single crystalline phases.

In one embodiment, a net shaped ceramic and/or metallic dental prosthesis device is fabricated by a (3D-LCVD) printer system. In one embodiment, a laser beam pyrolytically and/or photolytically decomposes a chemical vapor and forms a solidified ceramic and/or metallic microscopic volume on a substrate. In one embodiment, a plurality of adjoined individual solidified chemical vapor volumes are formed. In one embodiment, the plurality of individual adjoined solidified chemical vapor volumes form the net shaped ceramic and/or metallic dental prosthesis solid body. In one embodiment, comprising a plurality of ceramic forming chemical vapor precursors sources. In one embodiment, comprising a plurality of ceramic and/or metallic chemical vapor precursors for coloring the net shaped ceramic dental prosthesis. In one embodiment, comprising a plurality of metallic forming chemical vapor precursors.

In one embodiment, a dental device is disclosed comprising a net shaped ceramic solid body comprising at least thirty atomic percent zirconia, and further comprising a plurality of adjoined individual solidified chemical vapor volumes comprising said zirconia.

In one embodiment, a dental device is disclosed comprising a heterogeneous distribution of a plurality of adjoined individual solidified chemical vapor volumes comprising said zirconia, and further comprising a net shaped ceramic dental prosthesis comprised of said net shaped ceramic solid body.

In one embodiment, a dental device is disclosed comprising a method comprising a selective area deposition method for solidifying the chemical vapor volumes and forming a plurality of adjoined individual solidified chemical vapor volumes comprising said zirconia.

In one embodiment, a dental device is disclosed comprising a net shaped ceramic dental prosthesis characterized as having an optical transmittance for a one millimeter thickness of between forty percent and ninety-eight percent for a wavelength of light that is between three hundred eighty nanometers and seven hundred nanometers, and further comprising the net shaped ceramic body as having a flexural strength between six hundred mega-Pascals and two thousand five hundred mega-Pascals, and comprised of a ninety-eight percent theoretical density.

In one embodiment, a dental device is disclosed comprising a pluarality of individual solidified chemical vapor volumes comprising the zirconia net shape as having a size of at least one-tenth of a micrometer, and further comprising the plurality of adjoined individual solidified chemical vapor volumes comprising said zirconia in the form of a net shaped ceramic dental prosthesis comprising said heterogenous distribution of said zirconia.

In one embodiment, a dental device is disclosed comprising a ceramic dental device net shaped body comprised of at least thirty atomic percent zirconia, and further comprising a zirconia ceramic dental device comprised of: between thirty atomic percent zirconia and ninety-eight atomic percent zirconia, yttrium oxide between zero atomic percent yttria and sixty atomic percent yttria, silicon oxide between zero atomic percent silica and seventy atomic percent silica, aluminum oxide between zero atomic percent alumina and seventy atomic percent alumina.

In one embodiment, a dental device is disclosed comprising a net shaped ceramic solid body comprising at least 30 atomic % zirconia, and further comprising; between 0.1 atomic % and 20 atomic % of at least one oxide from a plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu), terbium (Tb), dysprosium (Dy), holmium (Ho), erbium (Er) and ytterbium (Yb).

In one embodiment, a dental device is disclosed comprising a net shaped ceramic solid body comprising at least 30 atomic % zirconia, and further comprising; between 0.1 atomic % and 20 atomic %, a combination of at least two oxides from the plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu), terbium (Tb), dysprosium (Dy), holmium (Ho), erbium (Er) and ytterbium (Yb).

In one embodiment, a dental device is disclosed comprising a net shaped ceramic solid body comprising at least 30 atomic % zirconia, and further comprising; between 0 atomic % and 5 atomic % of at least one element from a plurality of metallic elements comprising, silver (Ag), gold (Au), copper (Cu), platinum (Pt) and palladium (Pd), and further comprising a combination between 0 atomic % and 5 atomic % from a plurality of metallic elements comprising, silver (Ag), gold (Au), copper (Cu), platinum (Pt) and palladium (Pd), and wherein said plurality of metallic elements comprising, silver (Ag), gold (Au), copper (Cu), platinum (Pt) and palladium (Pd), and further comprised of a plurality of nanoparticles having a non-agglomerated size between 5 nm and 100 nm and further comprising said plurality of nanoparticles having an agglomerated size between 5 nm and 100 nm, and further comprising between 0 atomic % and 10 atomic % of at least one element from a plurality of elements comprising, carbon (C), nitrogen (N), fluorine (F), hydrogen (H), argon (Ar) and xenon (Xe), and further comprising a combination between 0 atomic % and 10 atomic % of said plurality of elements comprising, carbon (C), nitrogen (N), fluorine (F), hydrogen (H), argon (Ar) and xenon (Xe).

In one embodiment, a dental device is disclosed comprising a net shaped ceramic dental prosthesis, further comprising; a ceramic crown, and has an outer surface with a shape that substantially matches that of a tooth, and a plurality of adjoined said ceramic crown and forming a net shaped ceramic dental bridge prosthesis device, and further comprising; a first concave surface and a first convex surface, wherein said first convex surface is bonded to a concave surface of a dental implant abutment prosthesis substrate and forming a net shaped ceramic dental implant abutment that has a shape that substantially matches that of a custom dental implant abutment.

In one embodiment, a dental device is disclosed comprising a net shaped ceramic dental prosthesis, and further comprising; a first concave surface and a first convex surface, wherein said first convex surface is bonded to a concave surface of a dental implant body prosthesis substrate, and forming a net shaped ceramic dental implant body; and further comprising a net shaped ceramic dental orthodontic bracket prosthesis device.

In one embodiment, a dental device is disclosed comprising a plurality of solidified chemical vapor volumes comprised of zirconia, and further comprising; a predetermined three-dimensional architecture comprised of a heterogenous distribution of said zirconia in the form of a net shaped ceramic dental prosthesis in the form of a dental ceramic crown, wherein said dental ceramic crown comprises an optical transmittance that substantially matches that of a natural tooth optical transmittance.

In one embodiment, a dental device is disclosed comprising a method comprised of a selective area deposition method for solidifying a chemical vapor volume, and further comprising; a three-dimensional focused energy deposition method for solidifying the chemical vapor volumes, and further comprising; a three-dimensional laser chemical vapor deposition (3D-LCVD) method for solidifying the chemical vapor volumes.

In one embodiment, a dental device is disclosed comprising a plurality of individual solidified chemical vapor volumes comprised of zirconia, and further comprising; an amorphous zirconia phase, a nanocrystalline zirconia phase and said nanocrystalline zirconia phase size between 5 nm and 300 nm, further comprising a non-agglomerated said nanocrystalline zirconia phase and further comprising an agglomerated said nanocrystalline zirconia phase.

In one embodiment, a dental device is disclosed comprising a plurality of adjoined individual solidified chemical vapor volumes comprised of zirconia, and further comprising; a columnar single crystalline zirconia phase, characterized by a column width size and a column length size and a column length axis, and wherein said column width size is between 0.05 mm and 2 mm, and the column length size that is at least four times that of the column width size, and further comprising; a plurality of aligned single zirconia crystals, wherein the column length axis of an adjacently adjoined said plurality of aligned single zirconia crystals are substantially parallel.

In one embodiment, a dental device is disclosed comprising a plurality of adjoined individual solidified chemical vapor volumes comprised of zirconia, and further comprising; a predetermined heterogeneous distribution of an amorphous zirconia phase, a nanocrystalline zirconia phase and a single crystalline zirconia phase.

In one embodiment, a dental device is disclosed comprising net shaped zirconia solid body forming an artificial tooth and inhibits bacterial growth.

In one embodiment, a dental device is disclosed comprising a net shaped metallic solid body comprised of a plurality of adjoined individual solidified chemical vapor volumes comprised of a metallic element, wherein the individual solidified chemical vapor volumes comprising at least 20 atomic % of the metallic element from at least one element from a group of metallic elements comprising titanium (Ti), chromium (Cr) and cobalt (Co), and further comprising; a theoretical density of 98%, a heterogeneous distribution of said plurality of adjoined individual solidified chemical vapor volumes comprised of a metallic element in the form of a net shaped metallic dental prosthesis.

In one embodiment, a dental device is disclosed comprising a solidified chemical vapor volume comprised of a metallic element, and further comprising; between 1 atomic % and 80 atomic % of at least one element from a group of elements comprising carbon (C), aluminum (Al), titanium (Ti), chromium (Cr), cobalt (Co), vanadium (V), manganese (Mn), iron (Fe), nickel (Ni), copper (Cu), zinc (Zn), silicon (Si), niobium (Nb), molybdenum (Mo), zirconium (Zr), yttrium (Y), hafnium (Hf), tantalum (Ta), silver (Ag) and gold (Au).

In one embodiment, a dental device is disclosed comprising a net shaped metallic solid body further comprising; a net shaped metallic dental implant prosthesis device, comprising; a net shaped metallic dental implant abutment and a net shaped metallic dental implant body, and wherein the net shaped metallic dental implant prosthesis device has a shape that is substantially in the form of that of an artificial tooth root.

In one embodiment, a dental device is disclosed comprising a solidified chemical vapor volumes comprised of a metallic element further comprising; a predetermined heterogeneous distribution of an amorphous phase, and further comprising a nanocrystalline phase, and wherein said nanocrystalline phase has a nanocrystalline size between 5 nm and 100 nm.

In one embodiment, a dental device is disclosed comprising a method for manufacturing a net shaped dental prosthesis by a three-dimensional laser chemical vapor deposition printer the method comprised of the following steps: 1) importing data related to a three-dimensional computer-aided design (3D) (CAD) structure model of the net shaped dental prosthesis; 2) importing data related to a three-dimensional color bitmap of the net shaped dental prosthesis, comprising an optical chroma, and an optical transmittance into a chemical vapor based three-dimensional laser chemical vapor deposition (3D-LCVD) printer system.

In one embodiment, a dental device is disclosed comprising a (3D-LCVD) printer system which directly fabricates a net shaped dental prosthesis by selective area deposition manufacturing method, wherein the (3D-LCVD) printer has a deposited area manufacturing accuracy between 0.008 mm² and 314 mm², and wherein manufacturing height accuracy of said deposited area is between 0.1 μm and 20 μm.

In one embodiment, a dental device is disclosed comprising a (3D-LCVD) printer system method comprised of a sealed chamber with a partially transparent window which a laser beam is transmitted through, said laser beam having a wavelength of light between 148 nm and 10.6 mm, and further comprising a moveable platform comprised of a horizontal stage, said moveable platform substantially parallel to a horizontal plane on which a three-dimensional net shaped dental prosthesis is printed on, and wherein said laser beam intersects said moveable platform and said laser beam is substantially orthogonal to said moveable platform and contained within said sealed chamber.

In one embodiment, a dental device is disclosed comprising a (3D-LCVD) printer system method comprised of a precursor chemical vapor source comprising a precursor bubbler and a precursor vapor delivery gas tube, and wherein said precursor chemical vapor source comprises a metal-organic chemical, and a metal-halide chemical.

In one embodiment, a dental device is disclosed comprising a (3D-LCVD) printer system method comprised of a nozzle for receiving and directing a chemical vapor and said laser beam, wherein the laser beam is mechanically fastened to the nozzle, wherein the laser beam is substantially coaxial within the nozzle, and said laser beam and nozzle are moveable along a vertical plane.

In one embodiment, a dental device is disclosed comprising a (3D-LCVD) printer system method comprised of a printer system control unit for controlling a laser beam energy, and controlling a moveable platform, and said laser beam adjoined to a nozzle.

In one embodiment, a dental device is disclosed comprising a (3D-LCVD) printer system method comprised of utilizing the 3D-LCVD printer system to directly produce a net shaped dental prosthesis by a selective area deposition manufacturing by a computer controlled (3D-LCVD) printer system control unit, wherein the control unit controls the laser beam energy and a moveable platform to a predetermined position so as to pyrolytically and/or photolytically decompose and solidify said chemical vapor to form a particular solidified volume of a net shape. Additionally, adjusting; after each said particular solidified volume of the net shape is formed, the moveable platform moves a predetermined distance in the horizontal plane, and wherein a predetermined plurality of additional said particular solidified volume of the net shape is formed, forming a layer of adjoined solidified volumes; after said layer of adjoined solidified volumes of the net shape is formed, said laser beam and said nozzle move a predetermined distance along the vertical plane, wherein said layer of adjoined solidified volumes is repeated of the net shape is formed; and building up the net shape in successive layers of said layer of adjoined solidified volumes to a predetermined net shape based on the 3D CAD structure of the dental prosthesis.

In one embodiment, a dental device is disclosed comprising a (3D-LCVD) printer system method comprised of a chemical vapor further comprising; a chemical vapor precursor based on a metal, and comprising a metal-halide, and a metal-organic, wherein the chemical vapor comprising at least one element from a plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu), terbium (Tb), dysprosium (Dy), holmium (Ho), erbium (Er) and ytterbium (Yb), silver (Ag), gold (Au), palladium (Pd) and platinum (Pt), oxygen (O), nitrogen (N), hydrogen (H), argon (Ar) and xenon (Xe.

### BRIEF DESCRIPTION OF DRAWINGS

FIG. 1 is a cross-sectional view of a human tooth including a dental posterior prosthetic crown.

FIG. 2 is a cross-sectional view of a posterior crown for a tooth, including a net shaped dental prosthetic crown.

FIG. 3 is a cross-sectional view of an anterior crown for a tooth, including a net shaped dental prosthetic crown.

FIG. 4 is a cross-sectional view of a dental implant prosthesis.

FIG. 5 is a perspective view of a coordinate cartesian system and planes for reference purposes.

FIG. 6 is a block process flow diagram for fabricating a net shape dental prosthetic device.

FIG. 7 is a schematic side view of a three-dimensional laser chemical vapor deposition (3D-LCVD) printer system for fabricating dental prosthesis.

### DETAILED DESCRIPTION OF THE INVENTION

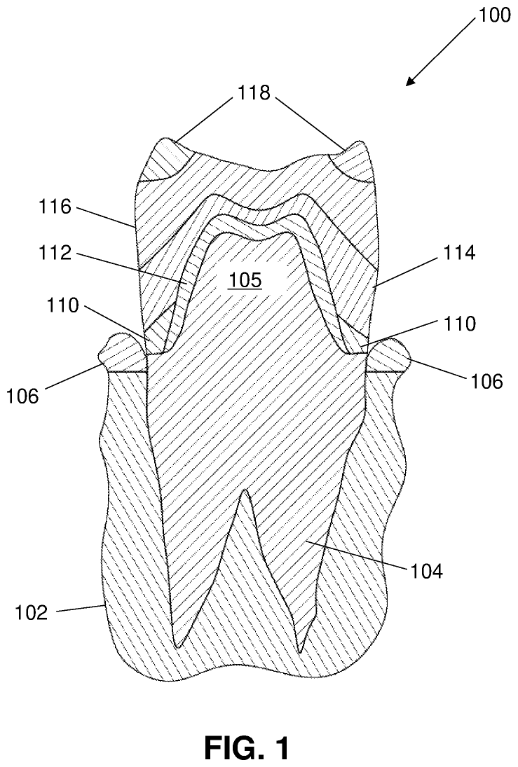

FIGS. 1 through FIG. 7 contain different views and embodiments describing this application. Figures may contain one or more of the referenced numbered components noted in the list below.

FIG. 1
100 cross-sectional view of a humans tooth
102 a bone
104 a tooth root
105 a tooth abutment
106 a gingiva tissue
110 a cervical region
112 a posterior first layer against a tooth abutment
114 a posterior crown second layer
116 a posterior crown third layer
118 a posterior crown cusp tip layer region

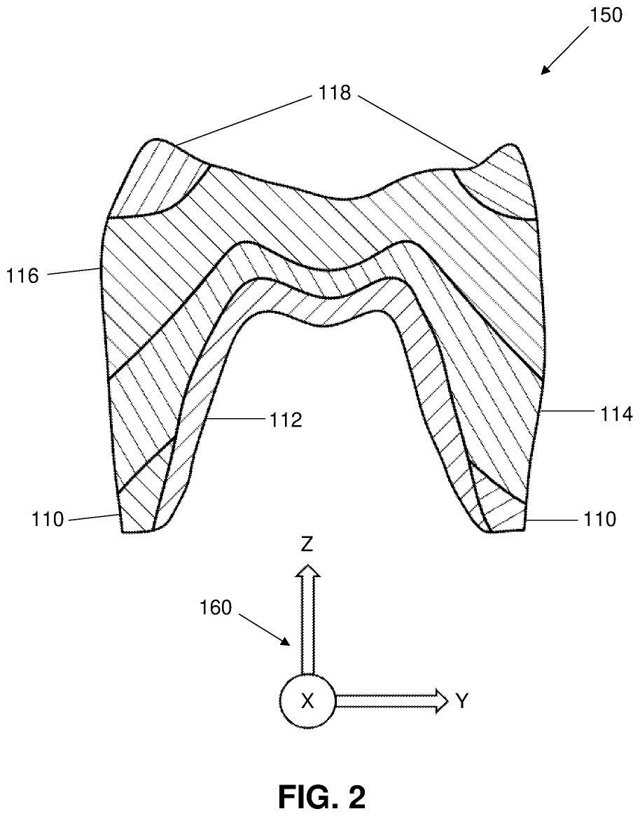

FIG. 2
150 cross-sectional view of a net shaped posterior crown
110 the cervical region
112 the first layer against the tooth abutment
114 the second layer
116 the third layer
118 the cusp tip layer region
160 orthogonal view of a cartesian coordinate system

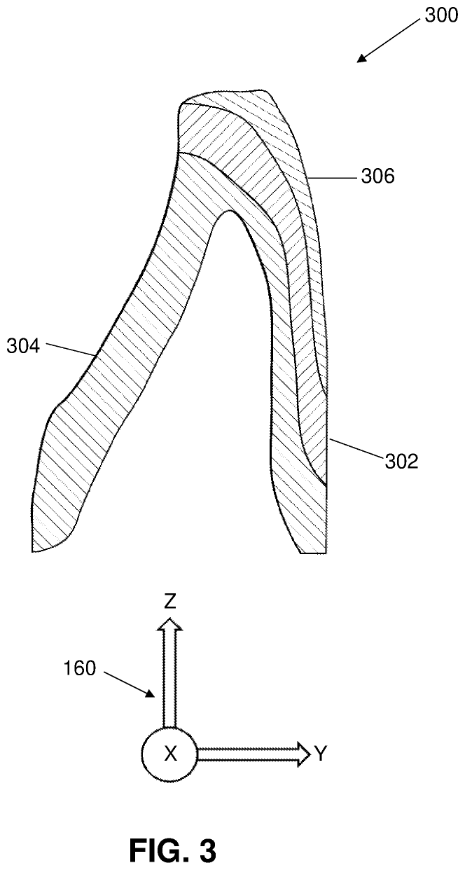

FIG. 3
300 cross-sectional view of a net shaped anterior crown
302 an anterior crown second layer
304 an anterior crown first layer
306 an anterior crown third layer
160 orthogonal view of a cartesian coordinate system

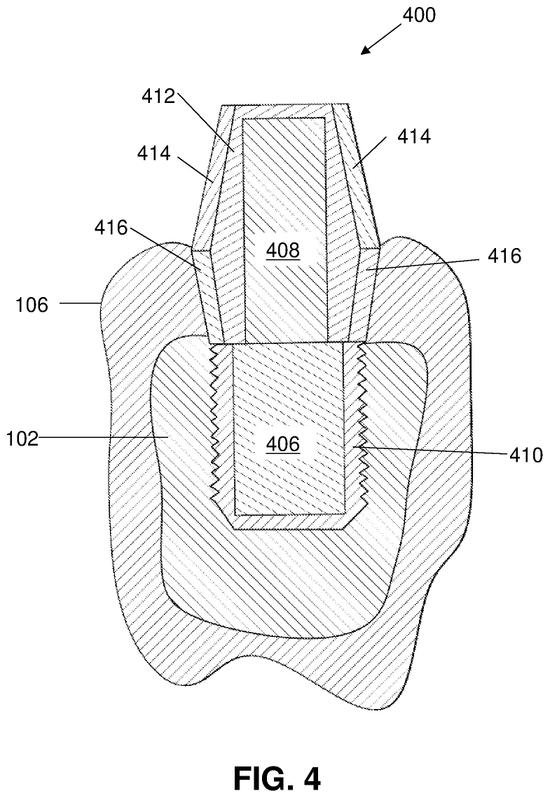

FIG. 4
400 cross-sectional view of the dental implant in a human bone
102 the bone
106 the gingiva tissue
406 an implant body substrate
408 an implant abutment substrate
410 a net shaped implant body layer
412 a net shaped implant abutment first layer
414 a net shaped implant abutment second layer
416 a net shaped implant abutment subgingival layer

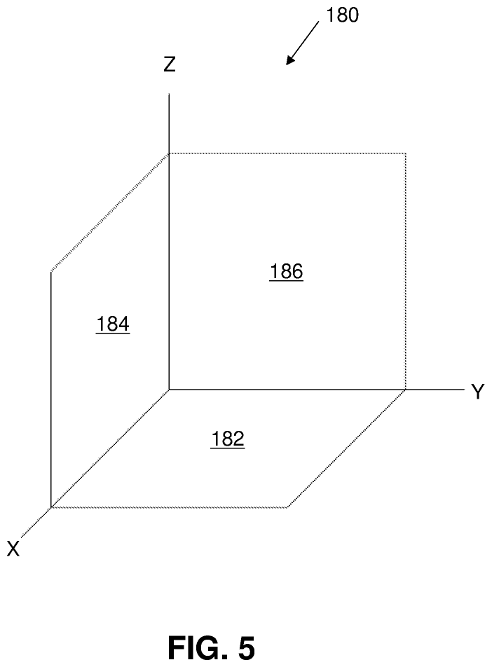

FIG. 5
180 a perspective view of Cartesian planes
182 a (XY) plane
184 a (XZ) plane
186 a (YZ) plane

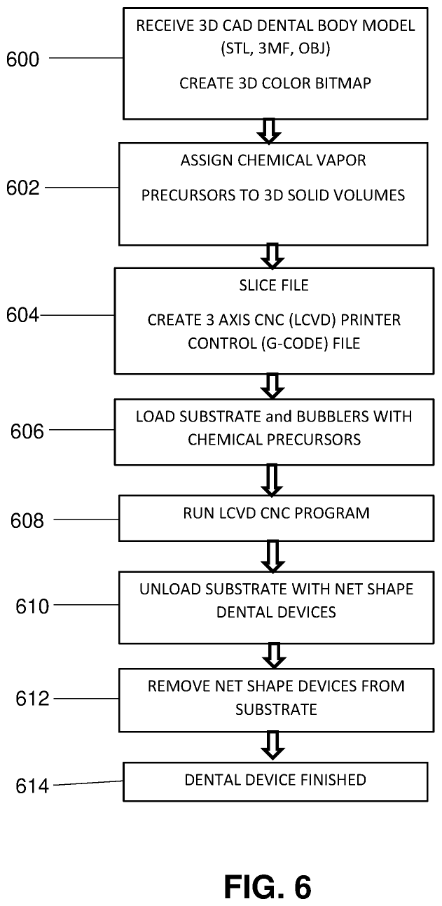

FIG. 6
600 a 3D solid dental body model
602 assign a plurality of chemical vapor precursors.
604 create a slice file and a three-dimensional laser chemical vapor deposition (3D-LCVD) printer (G-Code) file.
606 load a substrate and a plurality of bubblers
608 run the (3D-LCVD) computer control file
610 unload the substrate
612 remove the net shaped dental devices from the substrate.
616 finished

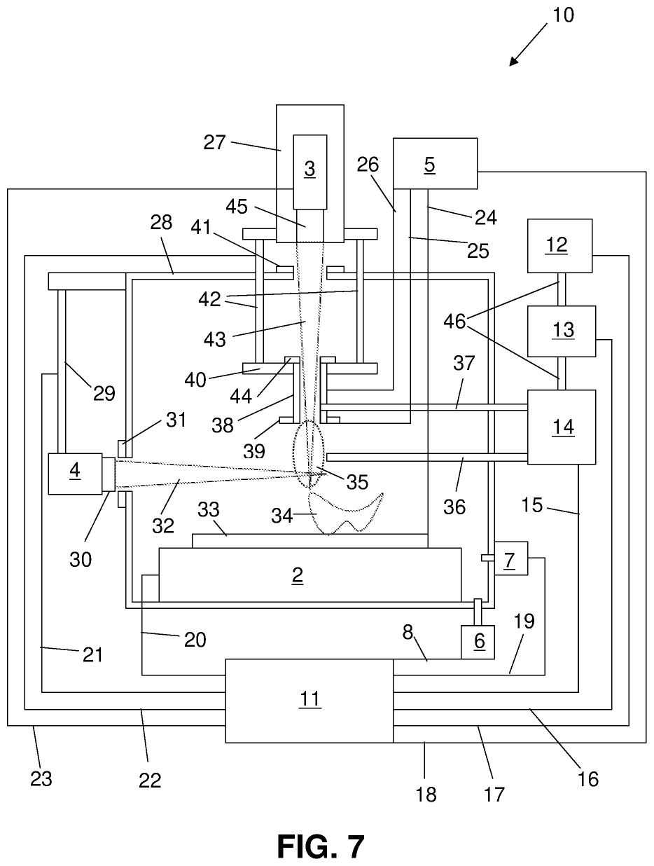

FIG. 7
10 schematic side view of the (LCVD) printer system
2 a moveable platform comprising a (XY) horizontal stage
3 a first laser source
4 a second laser source
5 an electrical power supply
6 a vacuum pump
7 a digital pressure gauge sensor
8 a vacuum pump electrical control cable
11 a (3D-LCVD) printer system control unit
12 a plurality of gas sources
13 a plurality of gas mass flow controllers
14 a plurality of chemical vapor sources
15 an electrical control cable for said chemical vapor sources
16 an electrical control cable for said plurality of gas mass flow controllers.
17 an electrical control cable for said plurality of gas sources.
18 an electrical control cable for said electrical power supply.
19 an electrical control cable for said digital pressure gauge sensor.
20 an electrical control cable for said (XY) horizontal stage.
21 an electrical control cable for said second laser source (Y) axis motor.
22 an electrical control cable for said first laser source (Z) axis motor.
23 an electrical control cable for said first laser source.
24 an electrical power cable for a substrate holder.
25 an electrical power cable for an electromagnetic energy source.
26 an electrical power cable for a nozzle
27 a laser source mounting structure
28 a chamber wall
29 a motor for said second laser source.
30 an optical collimator and a focusing lens for said second laser source.
31 an optical laser window feedthrough for said second laser source.
32 a laser beam of said second source laser.
33 a substrate mounted on said substrate holder.
34 a dental prosthesis
35 a chemical vapor reaction zone
36 a second chemical vapor source tube
37 a first chemical vapor source tube connected to a nozzle.
38 a chemical vapor delivery nozzle.
39 an electromagnetic energy source
40 a nozzle support structure
41 an optical laser window feedthrough for said first laser source.
42 a motor for said first laser source
43 a laser beam of said first laser source.
44 an optical window mounted on nozzle.
45 an optical collimator and a focusing lens for said first laser source.
46 a plurality of chemical vapor lines

FIG. 1 is a cross-sectional view of humans tooth 100, including a bone 102, a tooth root 104 that is embedded into the bone 102, a tooth abutment having been machined by a dentist in preparation for a crown 105 and a gingiva tissue 106. Additionally, a (3D-LCVD) fabricated net shape posterior dental crown is included, and comprising a net shaped zirconia ceramic cervical region comprising antimicrobial properties 110 adjoined to a posterior crown net shaped zirconia ceramic first layer 112, a posterior crown net shaped zirconia ceramic second layer 114 adjoined to the first layer 112, a posterior crown net shaped zirconia ceramic third layer 116 adjoined to the second layer 114, and a posterior crown cusp tips 118 adjoined to the third layer 116. Ceramic layers 110, 112, 114, 116 and 118 comprising zirconia and a plurality of metal oxides and metallic constituents. In another embodiment the net shaped crown first layer 112, adjacent to the prepared tooth abutment 105, first layer 112 comprising zirconia and silica and further comprising a plurality of net shaped surface texture for promoting the adhesion of a cement layer bonded to the ceramic first layer 112, wherein the cement layer is formed between tooth abutment 105 and the first layer of the crown 112. Within the net shaped crown is a second layer 114 and a third layer 116 comprising zirconia and a plurality of metal oxides for adjusting the zirconia crowns optical color and optical transmittance. The cross-sectional view of a human's tooth includes the gingiva tissue region 106. In one embodiment the net shaped cervical region 110 provides an esthetic gingiva tissue color mimicking a humans naturally colored gingiva tissue and further comprising antibacterial properties. In one embodiment the crowns third layer 116 comprises a zirconia silica composition and crystalline growth morphology to optimize the esthetic optical properties to substantially match the adjacent dentition.

FIG. 2 is an exemplary cross-sectional view of a (3D-LCVD) fabricated net shaped dental posterior zirconia crown prosthetic device, shown in view 150, comprising; a net shaped zirconia ceramic cervical region comprising antimicrobial properties 110, adjoined to a posterior crown net shaped zirconia ceramic first layer 112, a posterior crown net shaped zirconia ceramic second layer 114 adjoined to the first layer 112, a posterior crown net shaped zirconia ceramic third layer 116 adjoined to the second layer 114, and a posterior crown cusp tips 118 adjoined to the third layer 116. Ceramic layers 110, 112, 114, 116 and 118 comprising zirconia and a plurality of metal oxides and metallic constituents. In another embodiment the net shaped crown first layer 112, adjacent to the prepared tooth abutment 105, first layer 112 comprising zirconia and silica and further comprising a plurality of net shaped surface textures for promoting the adhesion of a cement layer bonded to the ceramic first layer 112, wherein the cement layer is formed between tooth abutment 105 and the first layer of the crown 112. Within the net shaped crown is a second layer 114 and a third layer 116 comprising zirconia and a plurality of metal oxides for fabricating the zirconia crowns optical color and optical transmittance. The cross-sectional view of a human's tooth includes the gingiva tissue region 106. In one embodiment the net shaped cervical region 110 provides an esthetic gingiva tissue color substantially matching that of a humans naturally colored gingiva tissue and further comprising antibacterial properties. In one embodiment the crowns third layer 116 comprises a zirconia silica composition and crystalline growth morphology to optimize the esthetic optical transmittance to substantially match that of a natural tooths dentition.

A cartesian coordinate system is shown in 160 for reference purposes. In one embodiment the net shaped zirconia crown is fabricated by a (3D-LCVD) printer resulting in the pyrolytic and/or photolytic decomposition and solidification of a chemical vapor applied to the surface of the 3D printed dental device. In one embodiment (3D-LCVD) printed layers are comprised of a plurality of chemical vapor precursors for forming a dental device comprising a plurality of compatible metal oxides to obtain the designated zirconia dental prosthesis optical transmittance and/or colorant. In one embodiment, a dental device is disclosed comprising a net shaped ceramic solid body comprising at least 30 atomic % zirconium oxide (ZrO₂) referred to as zirconia, and further comprising; between 0.1 atomic % and 20 atomic % of at least one oxide from a plurality of oxides comprising, hafnium oxide (HfO₂), yttrium oxide (Y₂O₃), magnesium oxides (MgO) and (MgO₂), calcium oxides (CaO) and (CaO₂), strontium oxides (SrO) and (SrO₂), scandium oxide (ScO₂), lanthanum oxide (La₂O₃), titanium oxide (TiO₂), vanadium oxides (VO), (V₂O₃), (VO₂) and (V₂O₅), niobium oxides (NbO), (NbO₂) and (Nb₂O₅), tantalum oxide (Ta₂O₅), chromium oxides (Cr₂O₃) and (CrO₂), molybdenum oxides (MoO₂) and (MoO₃), tungsten oxides (W₂O₃), (WO₂) and (WO₃), manganese oxides (MnO), (Mn₃O₄), (Mn₂O₃) and (MnO₂), iron oxides (FeO), (Fe₂O₃) and (Fe₃O₄), cobalt oxides (CoO), (Co₂O₃) and (Co₃O₄), nickel oxides (NiO) and (Ni₂O₃), copper oxides (Cu₂O) and (CuO), zinc oxide (ZnO), aluminum oxide (Al₂O₃), silicon oxides (SiO) and (SiO₂) phosphorous oxide (P₂O₅), bismuth oxide (Bi₂O₃), gallium oxide (Ga₂O₃), germanium oxide (GeO₂), cerium oxide (CeO₂), praseodymium oxides (PrO₂) and (Pr₂O₃), neodymium oxide (Nd₂O₃), samarium oxide (Sm₂O₃), europium oxide (Eu₂O₃), terbium oxides (Tb₄O₇), (Tb₂O₃), (TbO₂) and (Tb₆O₁₁), dysprosium oxide (Dy₂O₃), holmium oxide (Ho₂O₃), erbium oxide (Er₂O₃) and ytterbium (Yb₂O₃).

In one embodiment, exemplary metal and metal oxide compositions for forming the dental posterior crown 150; cervical regions 110 comprised of the following: composition 1: zirconia (99.9%-80.0%) and yttria (0.1%-20.0%), at. %; composition 2: zirconia (99.9%-70.0%) and yttria (0.1%-30.0%) and alumina (0.0%-25.0%) and terbium oxide (0.0%-1.5%) and erbium oxide (0.0%-30.0%) and silver (0.0%-1.0%) and molybdenum oxide (0.0%-2.0%), at. %; composition 3: zirconia (99.9%-70.0%) and yttria (0.1%-30.0%) and alumina (0.0%-25.0%) and terbium oxide (0.0%-1.5%), at. %; composition 4: zirconia (99.9%-70.0%) and yttria (0.1%-30.0%) and alumina (0.0%-25.0%) and erbium oxide (0.0%-30.0%), at. %; composition 5: zirconia (99.9%-70.0%) and yttria (0.1%-30.0%) and alumina (0.0%-25.0%) and terbium oxide (0.0%-1.5%) and erbium oxide (0.0%-30.0%) and silver (0.0%-1.0%) and molybdenum oxide (0.0%-2.0%), at. %.

In one embodiment, exemplary metal oxide compositions for forming the dental posterior crown 150; first layer 112 include the following: composition 1: zirconia (99.9%-80.0%) and yttria (0.1%-20.0%) at. %; composition 2: zirconia (99.9%-20.0%) and yttria (0.1%-80.0%) and alumina (0.0%-25.0%) and terbium oxide (0.0%-1.5%) and silicon oxide (0.0%-50.0%), at. %; composition 3: zirconia (99.9%-20.0%) and yttria (0.1%-80.0%) and alumina (0.0%-25.0%) and iron oxide (0.0%-1.5%) and silicon oxide (0.0%-50.0%), at. %.

In one embodiment, exemplary metal oxide compositions for forming the dental posterior crown 150, cusp tips 118 include the following: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and titanium oxide (0.0%-10.0%) and silicon oxide (0.0%-50.0%), at. %.

In one embodiment exemplary metal oxide compositions for forming the dental posterior crown 150, second layer 114 and third layer 116 include the following: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and terbium oxide (0.0%-1.5%) and silicon oxide (0.0%-50.0%), at. %; composition 3: zirconia (99.9%-20.0%) and yttria (0.1%-80.0%) and alumina (0.0%-25.0%) and iron oxide (0.0%-1.5%) and silicon oxide (0.0%-50.0%), at. %.

In one embodiment exemplary metal oxide compositions for forming the dental posterior crown 150, cervical region 110, first layer 112, second layer 114, third layer 116 and cusp tips 118, comprising a heterogeneous composition variation along the following planes: (XY) plane 182, (XZ) plane 184 and (YZ) plane 186, planes referenced in FIG. 5. A spatial compositional variation resolution of 10 μm within any of said planes.

FIG. 3 is an exemplary cross-sectional view of a (3D-LCVD) fabricated net shaped dental anterior zirconia crown, shown in overall view 300, first layer 304, second layer 302 and third layer 306 include the following metal oxide compositions: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and terbium oxide (0.0%-1.5%) and silicon oxide (0.0%-50.0%), at. %; composition 3: zirconia (99.9%-20.0%) and yttria (0.1%-80.0%) and alumina (0.0%-25.0%) and iron oxide (0.0%-1.5%) and silicon oxide (0.0%-50.0%), at. %.

FIG. 4 is an exemplary cross-sectional view of a (3D-LCVD) fabricated net shape dental implant prosthetic device as shown in view 400, comprising a bone 102, a gingiva tissue 106 which is attached to the bone 102, an implant body substrate 406, an implant abutment substrate 408, a net shaped body layer 410 which is fabricated on the body substrate 406 and attached to the bone 102, a net shaped implant abutment first layer 412 which is fabricated on the abutment substrate 408, a net shaped implant abutment second layer 414 which is fabricated on and bonded to the abutment first layer 412 and a net shaped implant abutment subgingival layer 416 which is fabricated on and bonded to abutment first layer 412.

In one embodiment the implant body substrate 406 is prefabricated, forming the body substrate 406 part placed into the bone 102. The body substrate 406, comprised of a dental biocompatible material such as: a zirconia solid ceramic and/or an alumina solid ceramic material, a solid metal alloy comprised of cobalt alloys, titanium alloys or materials comprising a ceramic-metal matrix.

In one embodiment the net shaped (3D-LCVD) fabricated body layer 410 is comprised of a plurality of metal oxides and/or a plurality of metallic elements; and/or a carbon material to provide for osseointegration into the bone 102; further comprising a hollow or porous skeletal framework; and further comprising an amorphous phase and/or or nanocrystalline phase to substantially promote osseointegration with the attached bone 102.

In one embodiment the abutment substrate 408 is prefabricated forming the abutment substrate 408 which is attached to a dental prosthesis. The abutment substrate 408, comprised of a dental biocompatible material such as: a zirconia solid ceramic and/or an alumina solid ceramic material, a solid metal alloy comprised of cobalt alloys, titanium alloys or materials comprising a ceramic-metal matrix.

In one embodiment the net shape (3D-LCVD) fabricated abutment first layer 412, the abutment second layer 414 and the subgingival layer 416 is comprised of a plurality of metal oxides and/or a plurality of metallic elements.

In one embodiment exemplary of prefabricated implant substrates 406 and 408, are fabricated by conventional methods, comprising material compositions such as: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and terbium oxide (0.0%-1.5%) at. %; composition 3: titanium (90%) and aluminum (6%) and vanadium (4%), wt. %, (commonly also known as Grade V titanium); composition 4: titanium (87%) and aluminum (6%) and niobium (7%), wt. %; and further comprising the following fabrication methods such as: conventional CNC machining, metal and/or ceramic injection molding followed by hot isostatic pressing (HIP).

In one embodiment exemplary composition and a growth morphology of the (3D-LCVD) net shaped implant body layer 410, comprising compositions such as: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and terbium oxide (0.0%-1.5%), at. %; composition 3: titanium (90%) and aluminum (6%) and vanadium (4%), wt. %, (commonly also known as grade V titanium); composition 4: titanium (87%) and aluminum (6%) and niobium (7%), wt. %; composition 5: titanium (95%-70%) and niobium (5%-30%) and zirconium (5%-30%) and oxygen (0%-5%), wt. %; composition 6: carbon (0%-100%), wt. %; and further comprising a (3D-LCVD) growth morphology, comprised of an amorphous morphology and/or a nanocrystalline growth morphology.

In one embodiment exemplary (3D-LCVD) printed metals, metal oxides and growth morphologies forming the abutment subgingival layer 416; comprising the following compositions, such as: composition 1: zirconia (99.9%-80.0%) and yttria (0.1%-20.0%), at. %; composition 2: zirconia (99.9%-70.0%) and yttria (0.1%-30.0%) and alumina (0.0%-25.0%) and terbium oxide (0.0%-1.5%) and erbium oxide (0.0%-30.0%) and silver (0.0%-1.0%) and molybdenum oxide (0.0%-2.0%), at. %; composition 3: zirconia (99.9%-70.0%) and yttria (0.1%-30.0%) and alumina (0.0%-25.0%) and terbium oxide (0.0%-1.5%), at. %; composition 4: zirconia (99.9%-70.0%) and yttria (0.1%-30.0%) and alumina (0.0%-25.0%) and erbium oxide (0.0%-30.0%), at. %; composition 5: zirconia (99.9%-70.0%) and yttria (0.1%-30.0%) and alumina (0.0%-25.0%) and terbium oxide (0.0%-1.5%) and erbium oxide (0.0%-30.0%) and silver (0.0%-1.0%) and/or molybdenum oxide (0.0%-2.0%), at. %; and further comprising a (3D-LCVD) growth morphology, comprised of an amorphous morphology and/or a nanocrystalline growth morphology.

In one embodiment exemplary (3D-LCVD) printed metals, metal oxides and growth morphologies forming the abutment first and second layers 412, 413 respectively, comprising the following compositions such as: composition 1: zirconia (99.9%-80.0%) and yttria (0.1%-20.0%), at. %; composition 2: zirconia (99.9%-20.0%) and yttria (0.1%-80.0%) and alumina (0.0%-25.0%) and terbium oxide (0.0%-1.5%) and silicon oxide (0.0%-50.0%), at. %; composition 3: zirconia (99.9%-20.0%) and yttria (0.1%-80.0%) and alumina (0.0%-25.0%) and iron oxide (0.0%-1.5%) and silicon oxide (0.0%-50.0%), at. %; composition 4: titanium (90%) and aluminum (6%) and vanadium (4%), wt. %, (commonly also known as grade V titanium); composition 5: titanium (87%) and aluminum (6%) and niobium (7%), wt. %; composition 6: titanium (95%-70%) and niobium (5%-30%) and zirconium (5%-30%) and oxygen (0%-5%); and further comprising a (3D-LCVD) growth morphology, comprised of an amorphous morphology and/or a nanocrystalline growth morphology.

FIG. 5 shows one embodiment of an exemplary view of a (XYZ) cartesian coordinate plane system, as shown in view 180. The Cartesian coordinate system comprising a (XY) plane 182, a (YZ) plane 186 and a (XZ) plane 184 is shown for reference.

FIG. 6 shows one embodiment of an exemplary depiction of the (3D-LCVD) dental device fabrication process flow. Receive 3D solid dental prosthetic device CAD digital virtual file in a file format comprising; a standard tessellation language (STL) format and/or a 3D manufacturing format (3MF) format and/or a wavefront object (OBJ) format; including optical transmittance and 3D color bitmap data 600. Assign chemical vapor precursor constituents 602 from the 3D color bitmap 600. Create a sliced file of 3D solid body to create the 3 axis computer numerical controlled (CNC) (3D-LCVD) printer system and laser control program and generate a geometric code (G-Code) file 604. Load a substrate to (3D-LCVD) print the dental device on and load the bubblers with the chemical vapor precursors 606. Execute the (CNC) (3D-LCVD) program 608. Unload the substrate with the (3D-LCVD) printed net shaped body 610. Remove the printed part from the substrate 612. Dental device (3D-LCVD) printing finished 614.

FIG. 7 shows one embodiment of an exemplary schematic side view of a (3D-LCVD) printer system method used for making a solid net shape dental prosthetic device, shown in 10. In one embodiment the (3D-LCVD) printer system comprising an exterior chamber wall 28 sealing the chamber interior such that the (3D-LCVD) process gaseous environment can be evacuated by a vacuum pump 7, operating at vacuum pressures between 10⁻⁷ bar to one bar as measured by a digital pressure gauge sensor 6, and/or pressurized to pressures between 1 bar and 200 bar. The (3D-LCVD) chamber wall is fabricated out of a stainless steel or an aluminum alloy comprised of a wall thickness between three millimeters to fifty millimeters. The (3D-LCVD) printer system 10 further comprising; A moveable platform comprising a (XY) horizontal stage 2, which translates the printed dental a predetermined amount, a motor for said second laser source 29, an optical collimator and a focusing lens for a second laser source 30, an optical laser window feedthrough for said second laser source 31, a laser beam of said second source laser 32, a chemical vapor reaction zone 35, a second chemical vapor source tube 36, an electromagnetic energy source 39, a motor for said first laser 42, a second laser source 4, an electrical power supply 5, a vacuum pump electrical control cable 8, a (3D-LCVD) printer system control unit 11, an electrical control cable for the chemical vapor sources 15, an electrical control cable for the plurality of gas mass flow controllers 16, an electrical control cable for said plurality of gas sources 17, an electrical control cable for the electrical power supply 18, an electrical control cable for said digital pressure gauge sensor 19, an electrical control cable for said (XY) horizontal stage 20, an electrical control cable for said second laser source (Y) axis motor 21, an electrical control cable for said first laser source (Z) axis motor 22, an electrical control cable for said first laser source 23, an electrical power cable for a substrate holder 24, an electrical power cable for an electromagnetic energy source 25, an electrical power cable for a nozzle 26.

In one embodiment the (3D-LCVD) printer system chemical vapor, carrier gas and reactant gases are introduced into the chamber through a first chemical vapor source tube connected to a nozzle 37, transporting a metal organic (MO) chemical vapor along with at least one or a plurality of carrier gases from a plurality of gas sources 12; gases, such as: argon (Ar), oxygen (O₂), nitrogen (N₂), clean dry air, helium (He), hydrogen (H₂), chlorine (Cl), fluorine (F), xenon (Xe), krypton (Kr), neon (Ne), bromine (Br), ethylene, methane and acetylene through at least one of a plurality of chemical vapor lines gas lines 46. Gas line 46 introduces pressurized gases, gas pressure ranging between 0.5 bar to 200 bar into at least one of a plurality of gas mass flow controllers (MFC) 13; delivering a controlled gas flow through a heated gas line 46 to a chemical vapor precursor source comprised of a plurality of chemical vapor sources 14. Gas lines 46 and precursor chemical vapor sources 14 are heated to a temperature ranging between three hundred Kelvin to six hundred Kelvin. The precursor chemical vapor source bubbler comprising precursors in a solid state, a liquid, a aerosolized or gaseous state.

In one embodiment the chemical vapor delivery nozzle 38 contains an optical window 44 secured to the nozzle 38 mounted to a nozzle support structure 40. A laser source 3 and a collimator and focusing lens 45 are mounted on a structure 27; beam of a first laser source 43 transmits through an optical laser window feedthrough for said first laser source 41, through chamber wall 28; and transmits through the nozzle window 44, into the nozzle 38 incident upon a printed dental device 34, mounted on a preheated substrate and substrate holder 33. The optical feedthrough windows 41 and 44 comprising materials such as: glass, quartz, sapphire, diamond, silicon, germanium, calcium fluoride, magnesium fluoride, potassium bromide, zinc selenide and barium fluoride.

In one embodiment the chemical vapor nozzle 38 is preheated to a temperature ranging between 300 Kelvin to 1300 Kelvin. Nozzle 38 mixes the gaseous contents from gas line 37 directing a jet of mixed states comprising heated chemical vapors, chemical vapor oligomers and/or clusters of condensed nanoparticles coaxial with a focused laser beam 43 incident upon the preheated dental device 34 and/or substrate 33. The mixed state gaseous jet exiting nozzle 38 comprising velocities ranging between 0.1 m/s to 400 m/s. The mixed state region between the focused beam 43 incident upon the printed dental device 34 induces a thermal diffusion region 35, between the laser incident spot and nozzle 38, inducing an increased preheating of the mixed gaseous state comprising chemical vapors and oligomers. The increased preheating of said mixed gaseous state, substantially accelerates the decomposition and condensation of oligomers and generation of nanoparticles comprising the gaseous jet incident upon the heated device 34.

In one embodiment the chemical vapor nozzle 38 further comprising an electromagnetic energy source 5 comprising a high voltage direct current source 24, ranging between 20 Volts to 20,000 Volts, alternating current ranging from 20 Volts to 2000 Volts comprising frequency ranging from 1 Hz to 10 THz, which induces a plasma formation within the nozzle 38 and/or the thermal diffusion region 35: and further comprising the nozzle 38 with an electrostatic and/or electromagnetic lens 39 comprising high voltage direct current ranging between 20 Volts to 20,000 Volts, alternating current ranging from 20 Volts to 2000 Volts comprising frequency ranging from 1 Hz to 10 THz; inducing the generation of a plasma formation within the nozzle 38 and/or the thermal diffusion region 35.

In one embodiment the chemical vapor nozzle 38 and a second chemical vapor source tube 36 are connected to a (Z) axis linear motion drive 42, to maintain a fixed predetermined distance from the growing 3D printed body 34. The second chemical vapor source tube 36 gaseous jet is directed perpendicular to the gaseous jet exiting nozzle 38 into the thermal diffusion region 35. The chemical vapor, gaseous constituents transporting through gas source tube 36 comprising a reduced temperature gaseous source of Ar, He, O2, N2, CO2, Ne, Kr, or Xe to rapidly quench the solidified chemical vapor on dental device 34.

In one embodiment the first focused laser beam energy source heats the substrate 33 and/or dental device 34 surface resulting in pyrolytic decomposition of the chemical vapor and following solidification. The substrate holder 33 is preheated by thermal conduction or by infrared radiation to a temperature between three hundred Kelvin and one thousand three hundred Kelvin.

In one embodiment a second laser source 4 and corresponding beam 32 comprised of a laser at wavelengths between one hundred forty-eight nanometers to eleven micrometers; further comprising a pulsed and/or continuous laser source, such as: a diode pumped solid state laser, fibers lasers and gas lasers.

In one embodiment the first laser source mounting structure 27 is mounted on a (Z) axis linear drive motor 42, and the second laser source 4 is mounted on (Z) axis linear motion 29. The (Z) axis linear drive motors 42 and 29 are computer controlled by the control unit 11 to maintain a fixed distance between the 3D printed dental device 34 and laser sources 3 and 4 during the printing process of the printed net shape solid body 34. In one embodiment the substrate 33 is fixed on a (XY) linear motion drive 2. The (XY) linear drive 2 motion is controlled by the control unit 11, to move the substrate to a predetermined location, under the focused laser energy beam 43 generating a plurality of adjoined solidified vapor volumes creating the net shaped printed dental device 34.

Alternatively, the (3D-LCVD) chamber is comprised of a fixed heated substrate with a chemical vapor region surrounding the 3D printed device area with an optical window mounted on a chamber, further comprising (XYZ) laser motion by a computer-controlled galvo mirror system mounted on the outside of the (LCVD) chamber.

In one exemplary embodiment control unit 11 is computer controlled, typically by a programmed general-purpose computer system, such as a personal computer, workstation and a server system. Includes one or more processors central processing units (CPUs), input/output circuitry, network adapter, and memory. (CPUs) execute program instructions in order to carry out the functions of embodiments of the present invention.

Input/output circuitry provides the capability to input data to, or output data from, a computer system. For example, input/output circuitry may include input devices, such as keyboards, mice, touchpads, trackballs, scanners, etc., output devices, such as video adapters, monitors, printers, etc., and input/output devices, such as, modems, etc. Network adapter, interfaces device with a network. Network may be any public or proprietary LAN or WAN, including, but not limited to the Internet.

Memory stores program instructions that are executed by, and data that are used and processed by, (CPU) to perform the functions of computer system. Memory may include, for example, electronic memory devices, such as random-access memory (RAM), read-only memory (ROM), programmable read-only memory (PROM), electrically erasable programmable read-only memory (EEPROM), flash memory.

In one embodiment exemplary metal organic (MO) and/or metal halide chemical precursors are noted below. The (3D-LCVD) printed materials are comprised of a plurality of metal organic chemical precursors that are comprised of a metal acetylacetonates.

In one embodiment (MO) and/or metal halide solid or liquid chemical vapor precursors that can be used for zirconium oxide (ZrO₂) and/or metallic zirconium (Zr) include: Tetrakis(dimethylamino)zirconium (IV), 98% (99.99%-Zr), (TDMAZ), Tetrakis(dimethylamino)-zirconium (IV), 99% TDMAZ, Tetrakis(ethylmethylamino)zirconium (IV) 99% TEMAZ, Tetrakis(2,2,6,6-tetramethyl-3,5-heptanedionato) zirconium (IV), 99% [Zr(TMHD)4], Zirconium (IV) acetylacetonate, minimum 97%, Zirconium (IV) t-butoxide (99.99%-Zr), Zirconium (IV) chloride, Zirconium (IV) hexafluoroacetylacetonate, Zirconium (IV) i-propoxide (isopropanol adduct) (99.9%-Zr), Zirconium (IV) trifluoroacetylacetonate, 99%, Zirconium (IV) dinitrate oxide hydrate. The above chemical vapor precursors are an example list, there are others that might be used known by those skilled in the art.

In one embodiment (MO) and/or metal halide solid or liquid chemical vapor precursors that can be used for yttrium oxide (Y₂O₃) and/or metallic zirconium (Zr) include: Yttrium (III) acetylacetonate, Yttrium (III) Acetylacetonate Hydrate, yttrium tris(2,2,6,6-tetramethyl-3,5-heptanedionate), Tris[N,N-bis (trimethylsilyl)amide]yttrium (III), min. 98% (99.9%-Y), Tris(butylcyclopentadienyl)yttrium (99.9%-Y), Yttrium (III) hexafluoroacetylacetonate, hydrate and yttrium chloride. The above chemical vapor precursors are an example list, there are others that might be used known by those skilled in the art.

In one embodiment (MO) and/or metal halide solid or liquid chemical vapor precursors that can be used for hafnium oxide (HfO₂) and/or metallic hafnium (HF) include: Hafnium acetylacetonate, Hafnium (IV) t-butoxide (99.9%-Hf, <1.5%-Zr), Tetrakis(dimethylamino)-hafnium, 98+% (99.99+%-Hf, <0.2% Zr) TDMAH, Tetrakis(2,2,6,6-tetramethyl-3,5-heptanedionato)hafnium (IV), 99% and hafnium chloride. The above chemical vapor precursors are an example list, there are others that might be used known by those skilled in the art.

In one embodiment (MO) solid or liquid chemical vapor precursors that can be used for aluminum oxide (Al2O3) and/or metallic aluminum (Al) include: Aluminium acetylacetonate, Aluminum s-butoxide, 98%, Aluminum hexafluoroacetylacetonate, min. 98%, Aluminum i-propoxide (99.99+%-Al) PURATREM, Hexakis(dimethylamino)dialuminum 98% (99.9%-Al) (TDMAA), Trimethylaluminum, elec. gr. (99.999+%-Al). The above chemical vapor precursors are an example list, there are others that might be used known by those skilled in the art.

In one embodiment (MO) and/or metal halide solid or liquid chemical vapor precursors that can be used for niobium oxide (NbO, NbO₂, Nb₂O₅) and/or metallic niobium (Nb) include: Niobium (V) ethoxide (99.9+%-Nb, Tetrakis (2,2,6,6-tetramethyl-3,5-heptanedionato) niobium (IV), 99% [Nb(TMHD)4]. The above chemical vapor precursors are an example list, there are others that might be used known by those skilled in the art.

In one embodiment (MO) and/or metal halide solid or liquid chemical vapor precursors that can be used for tantalum oxide (Ta₂O₅) and/or metallic tantalum (Ta) include: Tantalum (V) (tetraethoxy)(acetylacetonate) (99.99+%-Ta), Tantalum (V) ethoxide (99.99+%-Ta), Pentakis(dimethylamino)tantalum (V), minimum 98%, (t-Butylimido) tris(diethyl amino)tantalum (V), min. 98% (99.99%-Ta), Tantalum (V) chloride. The above chemical vapor precursors are an example list, there are others that might be used known by those skilled in the art.

In one embodiment (MO) and/or metal halide solid or liquid chemical vapor precursors that can be used for titanium oxide (TiO₂) and/or metallic titanium (Ti) include: Titanium (IV) oxide bis(acetylacetonate), min. 95%, Tetrakis(diethylamino)titanium (IV), 99%, Titanium (IV) t-butoxide (99.95%-Ti), Titanium (IV) chloride, 99%, Titanium (IV) ethoxide (99.99%-Ti). The above chemical vapor precursors are an example list, there are others that might be used known by those skilled in the art.

In one embodiment (MO) and/or metal halide solid or liquid chemical vapor precursors that can be used for calcium oxide (CaO) or metallic calcium (Ca) include: Calcium acetylacetonate hydrate, Calcium hexafluoroacetylacetonate dihydrate, 97%, Bis(2,2,6,6-tetramethyl-3,5-heptanedionato)calcium, min. 97%. The above chemical vapor precursors are an example list, there are others that might be used known by those skilled in the art.

In one embodiment (MO) and/or metal halide solid or liquid chemical vapor precursors that can be used for scandium oxide (Sc2O3) and/or metallic scandium (Sc) include: Scandium (III) acetylacetonate hydrate, Tris(2,2,6,6-tetramethyl-3,5-heptanedionato) scandium (III), 99% (99.9%-Sc). The above chemical vapor precursors are an example list, there are others that might be used known by those skilled in the art.

In one embodiment (MO) and/or metal halide solid or liquid chemical vapor precursors that can be used for Magnesium oxide (MgO) and/or metallic magnesium (Mg) include: Magnesium acetylacetonate, anhydrous, 98%, Bis(2,2,6,6-tetramethyl-3,5-heptanedionato) magnesium, anhydrous, min. 98% [Mg(TMHD)2. The above chemical vapor precursors are an example list, there are others that might be used known by those skilled in the art.

In one embodiment (MO) and/or metal halide solid or liquid chemical vapor precursors that can be used for zinc oxide (ZnO) and/or metallic zinc (Zn) include: Zinc acetylacetonate hydrate, Zinc chloride (99.99%-Zn), Bis[4,4,4-trifluoro-1-(2-thienyl-1,3-butanedionato]zinc TMEDA adduct, 99%, Zinc i-propoxide, 99%. The above chemical vapor precursors are an example list, there are others that might be used known by those skilled in the art.

In one embodiment (MO) and/or metal halide solid or liquid chemical vapor precursors that can be used for strontium oxide (SrO) and/or metallic strontium (Sr) include: Strontium acetylacetonate hydrate, Strontium hexafluoroacetylacetonate, Bis(2,2,6,6-tetramethyl-3,5-heptanedionato)strontium tetraglyme adduct (99.99%-Sr), Strontium chloride hexahydrate, 99%, Strontium hexafluoroacetylacetonate. The above chemical vapor precursors are an example list, there are others that might be used known by those skilled in the art.

In one embodiment (MO) and/or metal halide solid or liquid chemical vapor precursors that can be used for lanthanum oxide (La₂O₃) and/or metallic lanthanum (La) include: Lanthanum (III) acetylacetonate hydrate (99.9%-La), Lanthanum (III) chloride, anhydrous (99.9%-La), Tris(N,N′-di-i-propylformamidinato)lanthanum (III), (99.999+%-La) PURATREM La-FMD.

In one embodiment (MO) and/or metal halide solid or liquid chemical vapor precursors that can be used for ytterbium oxide (Yb₂O₃) and/or metallic ytterbium (Yb) include: Ytterbium Acetylacetonate, Ytterbium (III) chloride hydrate (99.99+%-Yb), Ytterbium (III) hexafluoroacetylacetonate dihydrate (99.9%-Yb), Tris(2,2,6,6-tetramethyl-3,5-heptanedionato) ytterbium (III), 99% (99.9%-Yb) (REO) [Yb(TMHD)3].

In one embodiment (MO) and/or metal halide solid or liquid chemical vapor precursors that can be used for cerium oxide (CeO2) and/or metallic cerium (Ce) include: Cerium (III) acetylacetonate hydrate (99.9%-Ce), Cerium (III) chloride hydrate (99.99%-Ce), Tetrakis(2,2,6,6-tetramethyl-3,5-heptanedionato)cerium (IV), min. 97% (99.9%-Ce), Cerium (III) trifluoroacetylacetonate hydrate.

In one embodiment (MO) and/or metal halide solid or liquid chemical vapor precursors can be used for adjusting dental device colorant, chromium oxide (Cr₂O₃) and/or metallic chromium (Cr) include: Chromium (III) acetylacetonate, 97.5%, Chromium (III) chloride, anhydrous (99.9%-Cr), Tris(2,2,6,6-tetramethyl-3,5-heptanedionato) chromium (III), 99% [Cr(TMHD)3].

In one embodiment (MO) and/or metal halide solid or liquid chemical vapor precursors that can be used for adjusting dental device colorant, manganese oxide (MnO, Mn3O4) and/or metallic manganese (Mn) include: Manganese (II) acetylacetonate, 95%, Manganese (II) chloride tetrahydrate (99.995%-Mn), Bis(cyclopentadienyl)manganese, 98+%, Cyclopentadienylmanganese tricarbonyl, 98%.

In one embodiment (MO) and/or metal halide solid or liquid chemical vapor precursors that can be used for adjusting dental device colorant, iron oxide (FeO, Fe₃O₄, Fe₂O₃) and/or metallic iron (Fe) include: Iron (III) acetylacetonate, 99%, iron chloride, Bis(N,N′-di-t-butylacetamidinato)iron (II), min. 98%, Bis(1, 1, 1, 5, 5, 5-hexafluoroacetylacetonato) (N,N, N′, N′tetramethylethylenediamine)iron (II), min. 98%, Tris(2,2,6,6-tetramethyl-3,5-heptanedionato)iron (III), 99% (99.9%-Fe) [Fe(TMHD)3], Iron (III) trifluoroacetylacetonate, 99% (99.9%-Fe).

In one embodiment (MO) and/or metal halide solid or liquid chemical vapor precursors that can be used for adjusting dental device colorant, cobalt oxide (CoO, Co₃O₄, Co₂O₃) and/or metallic cobalt (Co) include: Cobalt (II) acetylacetonate, Cobalt (II) chloride, anhydrous (99.998%-Co), Tris(2,2,6,6-tetramethyl-3,5-heptanedionato) cobalt (III), 99% (99.9+%-Co) [Co(TMHD)3].

In one embodiment (MO) and/or metal halide solid or liquid chemical vapor precursors that can be used for adjusting dental device colorant, nickel oxide (NiO,Ni₂O₃) and/or metallic nickel (Ni) include: Nickel (II) acetylacetonate, nickel chloride, Bis(N,N′-di-t-butylacetamidinato)nickel (II), (99.999%-Ni), Bis(2,2,6,6-tetramethyl-3,5-heptanedionato) nickel (II), min. 98% (99.9%-Ni) [Ni(TMHD)2].

In one embodiment (MO) and/or metal halide solid or liquid chemical vapor precursors that can be used for adjusting dental device colorant, copper oxide (CuO,Cu2O, Cu2O3) and/or metallic copper (Cu) include: Copper (II) acetylacetonate, copper chloride, Copper (I) bromide (99.99%-Cu), Bis(N,N′-di-sec-butylacetamidinato) dicopper (I), 99%, Bis(dimethylamino-2-propoxy)copper (II), min. 97% Cu(dmap)2, Bis(2,2,6,6-tetramethyl-3,5-heptanedionato)copper (II), 99% [Cu(TMHD)2].

In one embodiment (MO) and/or metal halide solid or liquid chemical vapor precursors that can be used for adjusting dental device colorant, gallium oxide (Ga₂O₃) include: Gallium acetylacetonate, Gallium (III) chloride, anhydrous, granular (99.999%-Ga), Trimethylgallium, elec. gr. (99.9999%-Ga), Bis(μ-dimethylamino)tetrakis (dimethylamino)digallium, 98%.

In one embodiment (MO) and/or metal halide solid or liquid chemical vapor precursors that can be used for adjusting dental device colorant, germanium oxide (GeO,G₂O) and/or metalloid germanium (Ge) include: Germanium (IV) ethoxide (99.99+%-Ge), Germanium (IV) ethoxide (99.99+%-Ge), Germanium (IV) chloride (99.9999%-Ge).

In one embodiment (MO) and/or metal halide solid or liquid chemical vapor precursors that can be used for adjusting dental device colorant, molybdenum oxide (MoO₂,MoO₃) and/or metallic molybdenum (Mo) include: Molybdenum (VI) dioxide bis(acetylacetonate), min. 95%, Molybdenum (V) chloride, anhydrous, 99.6%, Bis(t-butylimido) bis(dimethylamino)molybdenum (VI), 98%.

In one embodiment (MO) and/or metal halide solid or liquid chemical vapor precursors that can be used for adjusting dental device colorant, tungsten oxide (W₂O₃, WO₂, WO₃) and/or metallic tungsten (W) include: Tungsten (VI) chloride (99.9%-W), Bis(t-butylimido)bis(dimethylamino)tungsten (VI), min. 97%.

In one embodiment (MO) and/or metal halide solid or liquid chemical vapor precursors that can be used for adjusting dental device colorant, bismuth oxide (Bi₂O₃) and/or metallic bismuth (Bi) include: Bismuth (III) chloride, anhydrous (99.999%-Bi), Tris(2,2,6,6-tetramethyl-3,5-heptanedionato)bismuth (III), min. 98% (99.9%-Bi) [Bi(TMHD)3].

In one embodiment (MO) and/or metal halide solid or liquid chemical vapor precursors that can be used for adjusting dental device colorant, Praseodymium oxide (PrO₂, Pr₆O₁₁) and/or metallic Praseodymium (Pr) include: Praseodymium (III) acetylacetonate hydrate, Praseodymium (III) chloride, anhydrous (99.9%-Pr), Praseodymium (III) hexafluoroacetylacetonate (99.9%-Pr), Tris(2,2,6,6-tetramethyl-3,5-heptanedionato) praseodymium (III), 99% (99.9%-Pr) (REO) [Pr(TMHD)3].

In one embodiment (MO) and/or metal halide solid or liquid chemical vapor precursors that can be used for adjusting dental device colorant, neodymium oxide (Nd₂O₃) and/or metallic neodymium (Nd) include: Neodymium acetylacetonate, Neodymium (III) hexafluoroacetylacetonate dihydrate (99.9%-Nd), Neodymium (III) trifluoroacetylacetonate (99.9%-Nd), Tris(2,2,6,6-tetramethyl-3,5-heptanedionato) neodymium (III), 99%.

In one embodiment (MO) and/or metal halide solid or liquid chemical vapor precursors that can be used for adjusting dental device colorant, samarium oxide (Sm₂O₃) and/or metallic samarium (Sm) include: Samarium (III) Acetylacetonate Hydrate, Samarium (III) trifluoroacetylacetonate (99.9%-Sm), Tris(2,2,6,6-tetramethyl-3,5-heptanedionato) samarium (III) (99.9%-Sm) (REO) [Sm(TMHD)3].

In one embodiment (MO) and/or metal halide solid or liquid chemical vapor precursors that can be used for adjusting dental device colorant, europium oxide (Eu₂O₃) and/or metallic europium (Eu) include: Europium acetylacetonate, Europium acetylacetonate.

In one embodiment (MO) and/or metal halide solid or liquid chemical vapor precursors that can be used for adjusting dental device colorant, terbium oxide (Tb₂O₃, TbO₂, Tb₆O₁₁) and/or metallic terbium (Tb) include: Terbium (III) acetylacetonate hydrate, ris(2,2,6,6-tetramethyl-3,5-heptanedionato)terbium (III), 99% (99.9%-Tb), Terbium (III) chloride hydrate (99.995%-Tb).

In one embodiment (MO) and/or metal halide solid or liquid chemical vapor precursors that can be used for adjusting dental device colorant, dysprosium oxide (Dy₂O₃) and/or metallic dysprosium (Dy) include: Dysprosium Acetylacetonate, Dysprosium (III) chloride, anhydrous (99.9%-Dy), Tris(2,2,6,6-tetramethyl-3,5-heptanedionato) dysprosium (III), 98+% (99.9%-Dy).

In one embodiment (MO) and/or metal halide solid or liquid chemical vapor precursors that can be used for adjusting dental device colorant, erbium oxide (Er₂O₃) and/or metallic Erbium (Er) include: Erbium (III) acetylacetonate hydrate (99.9%-Er), Erbium (III) chloride hydrate (99.999%-Er), Erbium (III) hexafluoroacetylacetonate hydrate (99.9%-Er), Tris(2,2,6,6-tetramethyl-3,5-heptanedionato) erbium (III), 99% (99.9%-Er).

In one embodiment (MO) and/or metal halide solid or liquid chemical vapor precursors that can be used for adjusting dental device colorant, silicon oxide (SiO, SiO₂) and/or metalloid silicon (Si) include: Dimethyldiethoxysilane, 97%, Silicon (IV) bromide, 99+%, Tetraethoxysilane, min. 98% TEOS, Silicon tetrachloride.

In one embodiment (MO) and/or metal halide solid or liquid chemical vapor precursors that can be used for adjusting dental device colorant, silver oxide (Ag₂O) and/or metallic silver (Ag) include: 2,2,6,6-Tetramethyl-3,5-heptanedionato silver (I) (99.9%-Ag) [Ag(TMHD)], Triethylphosphine(6,6,7,7,8,8,8-heptafluoro-2,2dimethyl-3,5-octanedionate) silver (I), min. 98%, Silver chloride (99.9%-Ag).

In one embodiment (MO) and/or metal halide solid or liquid chemical vapor precursors that can be used for adjusting dental device colorant, metallic gold (Au) include: Gold (III) chloride, 99% (99.9%-Au), (N,N-Diethyldithiocarbamato) dimethylgold (III), 97% (99.999%-Au).

In one embodiment (MO) and/or metal halide solid or liquid chemical vapor precursors that can be used for adjusting dental device colorant, palladium oxide (PdO) and/or metallic paladium (Pd) include: Palladium (II) acetylacetonate, 99%, Palladium (II) chloride (99.9%-Pd), Palladium (II) hexafluoroacetylacetonate, min. 95%.

In one embodiment a chemical vapor precursor for carbon comprising compressed gases consisting of ethylene, methane, acetylene, carbon dioxide and further comprising liquid source toluene.

In one embodiment carrier gases and reactant gases are in the form of compressed gas bottles comprising argon (Ar), oxygen (O₂), nitrogen (N₂), clean dry air (nitrogen/oxygen), hydrogen (H₂), helium (He), chlorine (Cl), fluorine (F), bromine (Br), neon (Ne), krypton (Kr), xenon (Xe).

The foregoing description has been presented for the purposes of illustration and example. It is not intended to be exhaustive or to limit the invention to the precise form disclosed. It is intended that the scope of the invention be limited not by this description including these drawings, but rather by the claims appended hereto. Any advantages and benefits described may not apply to all embodiments of the invention.

1. A dental device, comprising:
a net shaped ceramic solid body comprising at least 30 atomic % zirconia;
a plurality of adjoined individual solidified chemical vapor volumes comprising said zirconia;
a heterogeneous distribution of said plurality of adjoined individual solidified chemical vapor volumes comprising said zirconia;
a net shaped ceramic dental prosthesis comprised of said net shaped ceramic solid body; and
a selective area deposition means for solidifying the chemical vapor volumes and forming said plurality of adjoined individual solidified chemical vapor volumes comprising said zirconia;
wherein the net shaped ceramic dental prosthesis is characterized as having an optical transmittance for a 1 mm thickness of between 40% and 98% for a wavelength of light that is between 380 nm and 700 nm, and a flexural strength between 600 mega-Pascals and 2500 mega-Pascals, and a 98% theoretical density; and
wherein the individual solidified chemical vapor volumes comprising said zirconia have a size of at least 0.1 μm, whereby said plurality of adjoined individual solidified chemical vapor volumes comprising said zirconia form the net shaped ceramic dental prosthesis comprising said heterogenous distribution of said zirconia.

2. The device of claim 1, wherein the net shaped ceramic solid body comprising at least 30 atomic % zirconia, further comprising; between 30 atomic % zirconia and 98 atomic % zirconia and an yttrium oxide between 0 atomic % yttria and 60 atomic % yttria, a silicon oxide between 0 atomic % silica and 70 atomic % silica, and an aluminum oxide between 0 atomic % alumina and 70 atomic % alumina.

3. The device of claim 1, wherein the net shaped ceramic solid body comprising at least 30 atomic % zirconia, further comprising; between 0.1 atomic % and 20 atomic % of at least one oxide from a plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu) terbium (Tb), dysprosium (Dy), holmium (Ho), erbium (Er) and ytterbium (Yb).

4. The device of claim 1, wherein the net shaped ceramic solid body comprising at least 30 atomic % zirconia, further comprising; between 0.1 atomic % and 20 atomic %, a combination of at least two oxides from the plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu) terbium (Tb), dysprosium (Dy), holmium (Ho), erbium (Er) and ytterbium (Yb).

5. The device of claim 1, wherein the net shaped ceramic solid body comprising at least 30 atomic % zirconia, further comprising; between 0 atomic % and 5 atomic % of at least one element from a plurality of metallic elements comprising, silver (Ag), gold (Au), copper (Cu), platinum (Pt) and palladium (Pd), and further comprising a combination between 0 atomic % and 5 atomic % from a plurality of metallic elements comprising, silver (Ag), gold (Au), copper (Cu), platinum (Pt) and palladium (Pd), and wherein said plurality of metallic elements comprising, silver (Ag), gold (Au), copper (Cu), platinum (Pt) and palladium (Pd), and further comprised of a plurality of nanoparticles having a non-agglomerated size between 5 nm and 100 nm and further comprising said plurality of nanoparticles having an agglomerated size between 5 nm and 100 nm, and further comprising between 0 atomic % and 10 atomic % of at least one element from a plurality of elements comprising, carbon (C), nitrogen (N), fluorine (F), hydrogen (H), argon (Ar) and xenon (Xe), and further comprising a combination between 0 atomic % and 10 atomic % of said plurality of elements comprising, carbon (C), nitrogen (N), fluorine (F), hydrogen (H), argon (Ar) and xenon (Xe).

6. The device of claim 1, wherein the net shaped ceramic dental prosthesis, further comprising; a ceramic crown, and has an outer surface with a shape that substantially matches that of a tooth, and a plurality of adjoined said ceramic crown and forming a net shaped ceramic dental bridge prosthesis device, and further comprising; a first concave surface and a first convex surface, wherein said first convex surface is bonded to a concave surface of a dental implant abutment prosthesis substrate and forming a net shaped ceramic dental implant abutment that has a shape that substantially matches that of a custom dental implant abutment.

7. The device of claim 1, wherein the net shaped ceramic dental prosthesis, further comprising; a first concave surface and a first convex surface, wherein said first convex surface is bonded to a concave surface of a dental implant body prosthesis substrate, and forming a net shaped ceramic dental implant body; and further comprising a net shaped ceramic dental orthodontic bracket prosthesis device.

8. The device of claim 1, wherein the solidified chemical vapor volumes comprising said zirconia further comprising; a predetermined three-dimensional architecture comprised of said heterogenous distribution of said zirconia in the form of said net shaped ceramic dental prosthesis in the form of a dental ceramic crown, wherein said dental ceramic crown comprises an optical transmittance that substantially matches that of a natural tooth optical transmittance.

9. The device of claim 1, wherein the selective area deposition means for solidifying the chemical vapor volumes further comprising; a three-dimensional focused energy deposition means for solidifying the chemical vapor volumes, and further comprising; a three-dimensional laser chemical vapor deposition (3D-LCVD) means for solidifying the chemical vapor volumes.

10. The device of claim 1, wherein the individual solidified chemical vapor volumes comprising said zirconia further comprising; an amorphous zirconia phase, a nanocrystalline zirconia phase and said nanocrystalline zirconia phase size between 5 nm and 300 nm, further comprising a non-agglomerated said nanocrystalline zirconia phase and further comprising an agglomerated said nanocrystalline zirconia phase.

11. The device of claim 1, wherein the plurality of adjoined individual solidified chemical vapor volumes comprising zirconia further comprising; a columnar single crystalline zirconia phase, characterized by a column width size and a column length size and a column length axis, and wherein said column width size between 0.05 um and 2 μm, and the column length size that is at least four times that of the column width size, and further comprising; a plurality of aligned single zirconia crystals, wherein the column length axis of an adjacently adjoined said plurality of aligned single zirconia crystals are substantially parallel.

12. The device of claim 1, wherein the plurality of adjoined individual solidified chemical vapor volumes comprising zirconia further comprising; a predetermined heterogeneous distribution of an amorphous zirconia phase, a nanocrystalline zirconia phase and a single crystalline zirconia phase.

13. A dental device, comprising:
a net shaped metallic solid body; and
a plurality of adjoined individual solidified chemical vapor volumes comprising of a metallic element;
wherein the individual solidified chemical vapor volumes comprising at least 20 atomic % of the metallic element from at least one element from a group of metallic elements comprising titanium (Ti), chromium (Cr) and cobalt (Co);
a theoretical density of 98%;
a heterogeneous distribution of said plurality of adjoined individual solidified chemical vapor volumes comprised of a metallic element forming said metallic solid body; and
a net shaped metallic dental prosthesis comprised of the net shaped metallic solid body; whereby said net shaped dental prosthesis device is comprised of the net shaped solid body.

14. The device of claim 13, wherein the solidified chemical vapor volumes comprising of a metallic element further comprising; between 1 atomic % and 80 atomic % of at least one element from a group of elements comprising carbon (C), aluminum (AI), titanium (Ti), chromium (Cr), cobalt (Co), vanadium (V), manganese (Mn), iron (Fe), nickel (Ni), copper (Cu), zinc (Zn), silicon (Si), niobium (Nb), molybdenum (Mo), zirconium (Zr), yttrium (Y), hafnium (Hf), tantalum (Ta), silver (Ag) and gold (Au).

15. The device of claim 13, wherein the net shaped metallic solid body further comprising; a net shaped metallic dental implant prosthesis device, comprising; a net shaped metallic dental implant abutment and a net shaped metallic dental implant body, and wherein the net shaped metallic dental implant prosthesis device has a shape that is substantially in the form of that of an artificial tooth root.

16. The device of claim 13, wherein the solidified chemical vapor volumes comprising of a metallic element further comprising; a predetermined heterogeneous distribution of an amorphous phase, and further comprising a nanocrystalline phase, and wherein said nanocrystalline phase has a nanocrystalline size between 5 nm and 100 nm.

17. A method for manufacturing a net shaped dental prosthesis by a three-dimensional laser chemical vapor deposition printer, said method comprising:
importing data related to a three-dimensional computer-aided design (3D) (CAD) structure model of the net shaped dental prosthesis and importing data related to a three-dimensional color bitmap of the net shaped dental prosthesis, comprising an optical chroma, and an optical transmittance into a chemical vapor based said three-dimensional laser chemical vapor deposition printer, and comprising a (3D-LCVD) system; and
directly producing the net shaped dental prosthesis in the 3D-LCVD printer system by selective area deposition manufacturing, wherein a deposited area manufacturing accuracy between 0.008 μm² and 314 μm², and wherein manufacturing height accuracy of said deposited area between 0.1 μm and 20 μm.

18. The method of claim 17, wherein the three-dimensional laser chemical vapor deposition printer, further comprising;
a sealed chamber with a partially transparent window which a laser beam is transmitted through, said laser beam having a wavelength of light between 148 nm and 10.6 μm;
a moveable platform comprising a horizontal stage, said moveable platform substantially parallel to a horizontal plane on which said three-dimensional net shaped dental prosthesis is printed on, and wherein said laser beam intersects said moveable platform and said laser beam is substantially orthogonal to said moveable platform and contained within said sealed chamber;
a precursor chemical vapor source comprising a precursor bubbler and a precursor vapor delivery gas tube, and wherein said precursor chemical vapor source comprises a metal-organic chemical, and a metal-halide chemical;
a nozzle for receiving and directing said chemical vapor and said laser beam, wherein the laser beam is mechanically fastened to the nozzle, wherein the laser beam is substantially coaxial within the nozzle, and said laser beam and nozzle are moveable along a vertical plane; and
a printer system control unit for controlling said laser beam energy and controlling said moveable platform, and said laser beam and said nozzle;
wherein the method further comprises utilizing the 3D-LCVD printer system to directly produce the net shaped dental prosthesis by said selective area deposition manufacturing by;
controlling, by the system control unit, the laser beam energy and the moveable platform, and a predetermined position so as to thermally decompose and solidify said chemical vapor to form a particular solidified volume of a net shape;
adjusting, after each said particular solidified volume of the net shape is formed, the moveable platform moves a predetermined distance in the horizontal plane, and wherein a predetermined plurality of additional said particular solidified volume of the net shape is formed, forming a layer of adjoined solidified volumes;
adjusting, after said layer of adjoined solidified volumes of the net shape is formed, said laser beam and said nozzle move a predetermined distance along the vertical plane, wherein said layer of adjoined solidified volumes is repeated of the net shape is formed; and
building up the net shape in successive layers of said layer of adjoined solidified volumes to a predetermined net shape based on the 3D CAD structure of the dental prosthesis.

19. The method of claim 17, wherein the chemical vapor further comprising;
a chemical vapor precursor based on a metal, and comprising a metal-halide, and a metal-organic, wherein the chemical vapor comprising at least one element from a plurality of elements comprising, hafnium (Hf), yttrium (Y), magnesium (Mg), calcium (Ca), strontium (Sr), scandium (Sc), lanthanum (La), titanium (Ti), vanadium (V), niobium (Nb), tantalum (Ta), chromium (Cr), molybdenum (Mo), tungsten (W), manganese (Mn), iron (Fe), cobalt (Co), nickel (Ni), copper (Cu), zinc (Zn), aluminum (Al), silicon (Si), phosphorous (P), bismuth (Bi), gallium (Ga), germanium (Ge), cerium (Ce), praseodymium (Pr), neodymium (Nd), samarium (Sm), europium (Eu) terbium (Tb), dysprosium (Dy), holmium (Ho), erbium (Er) and ytterbium (Yb), silver (Ag), gold (Au), palladium (Pd) and platinum (Pt), oxygen (O), nitrogen (N), hydrogen (H), argon (Ar) and xenon (Xe.
